(19) United States
(12) Patent Application Publication
(10) Pub. No.: US 2007/0225446 A1
(43) Pub. Date: Sep. 27, 2007

(54) Plastic elastomer compositions and air bag cover

(75) Inventors: Sadayuki Nakano, Chiba (JP); Noboru Komine, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/712,455

(22) Filed: Mar. 1, 2007

(30) Foreign Application Priority Data
Mar. 24, 2006 (JP) 2006-082763
May 18, 2006 (JP) 2006-138505

(51) Int. Cl. C08L 23/04

(52) U.S. Cl. 525/240

(57) ABSTRACT

A resin composition for impact-resistant moldings with high low-temperature impact strength, and an air bag cover made of this resin composition are provided. The resin composition, or a thermoplastic elastomer composition for impact-resistant moldings, is produced by a process comprising subjecting 15 to 40% by weight of component (A), 15 to 40% by weight of component (B) and 20 to 70% by weight of component (C) (taking the total of the components (A), (B) and (C) as 100% by weigh) to a dynamic heat treatment in the presence of a crosslinking agent, said components being as specified below:

(A): an ethylene-α-olefin-non-conjugated diene copolymer rubber having a density of 850 to 900 kg/m³, a Mooney viscosity (ML₁₊₄(100° C.)) of 30 to 150, and an ethylene unit content of 30 to 90;

(B): an ethylene-α-olefin-non-conjugated diene copolymer rubber having a density of 850 to 900 kg/m³ and a Mooney viscosity (ML₁₊₄(100° C.)) of 30 to 150, and an ethylene unit content which is 0.50 to 0.95 time that of the component (A) or an iodine value which is 0.25 to 0.95 time that of the component (A);

(C): a polypropylene resin.

### FIELD OF THE INVENTION

The present invention relates to thermoplastic elastomer compositions having excellent low-temperature impact strength and fluidity, and an air bag cover which is obtained by molding the compositions.

### BACKGROUND OF THE INVENTION

It is required of an air bag cover that in the event of a car crash, it bursts infallibly to let the air bag bounce out and spread immediately without its broken pieces being scattered away, that it has enough low-temperature strength to endure use even in a cold district, and that it is easy to mold. As the materials used for such an air bag cover, there are known, for example, a resin composition comprising polypropylene having a melt flow rate (MFR) at 230° C. of 14 g/10 min and a linear low-density polyethylene having MFR at 190° C. of 4 g/10 min and a density of 915 kg/m³, a resin composition comprising polypropylene having MFR at 230° C. of 30 g/10 min and an ethylene content of 3% by weight and an ethylene-octene copolymer rubber having MFR at 230° C. of 8 g/10 min and a comonomer content of 24% by weight, and a resin composition comprising polypropylene having MFR at 230° C. of 50 g/10 min and an ethylene-octene copolymer rubber having MFR at 230° C. of 2.3 g/10 min and a comonomer content of 24% by weight. The materials having a rigidity of about 150 to 400 MPa and showing survival in a −40° C. Izod impact test have also been proposed. (See Patent Document 1, Patent Document 2 and Patent Document 3.)
[Patent Document 1] JP-A-8-27331
[Patent Document 2] JP-A-10-265628
[Patent Document 3] JP-A-2001-279030

### BRIEF SUMMARY OF THE INVENTION

The air bag covers made of the above compositions, however, have the problem that their low-temperature impact strength is unsatisfactory.

In view of these circumstances, the present invention is envisioned to provide an air bag cover having excellent low-temperature impact strength, and the thermoplastic elastomer compositions suited for producing such an air bag cover.

In one embodiment of the present invention, there is provided a thermoplastic elastomer composition obtained by mixing, at least, 15 to 40% by weight of the component (A1), 15 to 40% by weight of the component (B1) and 20 to 70% by weight of the component (C) (taking the total of the components (A1), (B1) and (C) as 100% by weight), said components being as specified below:
(A1): an ethylene-α-olefin-non-conjugated diene copolymer rubber having a density of 850 to 900 kg/m³, a Mooney viscosity (ML₁₊₄(100° C.)) of 30 to 150, an iodine value of 0.1 to 40, and an ethylene unit content of 30 to 90;
(B1): an ethylene-α-olefin-non-conjugated diene copolymer rubber having a density of 850 to 900 kg/m³, a Mooney viscosity (ML₁₊₄(100° C.)) of 30 to 150, an iodine value of 0.1 to 40, and an ethylene unit content which is 0.50 to 0.95 time that of the component (A1);
(C): a polypropylene resin.

In another embodiment of the present invention, it provides a thermoplastic elastomer composition obtained by mixing, at least, 15 to 40% by weight of a component (A2), 15 to 40% by weight of a component (B2) and 20 to 70% by weight of a component (C) (taking the total of a components (A2), (B2) and (C) as 100% by weight), said components being as specified below:
(A2): an ethylene-α-olefin-non-conjugated diene copolymer rubber having a density of 850 to 900 kg/m³, a Mooney viscosity (ML₁₊₄(100° C.)) of 30 to 150, an ethylene unit content of 30 to 90 and an iodine value of 0.1 to 40;
(B2): an ethylene-α-olefin-non-conjugated diene copolymer rubber having a density of 850 to 900 kg/m³, a Mooney viscosity (ML₁₊₄(100° C.)) of 30 to 150, an ethylene unit content of 30 to 90 and an iodine value which is 0.25 to 0.95 time that of the component (A2);
(C): a polypropylene resin.

The present invention also pertains to an air bag cover made of either of the said thermoplastic elastomer compositions.

### ADVANTAGES OF THE INVENTION

According to the present invention, it is realized to provide the plastic elastomer compositions with high low-temperature impact strength, and an air bag cover made of such compositions.

### DETAILED DESCRIPTION OF THE INVENTION

The first embodiment of the present invention is described below.

The thermoplastic elastomer composition in the first embodiment of the present invention comprises at least three components, viz. (A1) an ethylene-α-olefin-non-conjugated diene copolymer rubber having a density of 850 to 900 kg/m³, a Mooney viscosity (ML₁₊₄(100° C.)) of 30 to 150, an iodine value of 0.1 to 40, and an ethylene unit content of 30 to 90, (B1) an ethylene-α-olefin-non-conjugated diene copolymer rubber having a density of 850 to 900 kg/m³, a Mooney viscosity (ML₁₊₄(100° C.)) of 30 to 150, an iodine value of 0.1 to 40, and an ethylene unit content which is 0.50 to 0.95 time that of the component (A1), and (C) a polypropylene resin.

As the ethylene-α-olefin-non-conjugated diene copolymer rubber serving as the component (A1) or (B1) in the present invention, it is possible to use a mixture of an ethylene-α-olefin-non-conjugated diene copolymer rubber and a softening agent (which is also called “extender oil”), namely a softening agent-extended ethylene-α-olefin-non-conjugated diene copolymer rubber. The following methods can be exemplified for mixing an ethylene-α-olefin-non-conjugated diene copolymer rubber and a softening agent: (1) an ethylene-α-olefin-non-conjugated diene copolymer rubber as a finished product (which may be a commercial product) and a softening agent are mixed by a known mixing machine; (2) a solution of the intermediate in the production of an ethylene-α-olefin-non-conjugated diene copolymer rubber is mixed with a softening agent to form a mixture, and then the solvent is removed from the mixture.

As the softening agent, mineral oils such as paraffinic, naphthenic and aromatic mineral oils can be cited as examples, with paraffinic mineral oils being preferred. The amount of the softening agent to be mixed with said copolymer rubber should be selected so that the Mooney viscosity (ML₁₊₄(100° C.)) of the ethylene-α-olefin-non-conjugated diene copolymer rubber after addition of the softening agent will stay in the range of 30 to 150. The amount of the softening agent added is usually 20 to 200 parts by weight, preferably 20 to 150 parts by weight, more preferably 20 to 120 parts by weight, per 100 parts by weight of the ethylene-α-olefin-non-conjugated diene copolymer rubber which does not contain the softening agent. If the content of the softening agent is less than 20 parts by weight, the produced thermoplastic elastomer composition may prove unsatisfactory in fluidity. On the other hand, if the content of the softening agent exceeds 200 parts by weight, low-temperature strength of the produced elastomer composition may deteriorate.

The α-olefin in the said copolymer rubber is usually one with a carbon number of 3 to 10. Exemplary of such α-olefins are linear α-olefins such as propylene, 1-butene, 1-pentene, 1-hexene, 1-octene and 1-decene; and branched α-olefins such as 3-methyl-1-butene and 3-methyl-1-pentene. Of these α-olefins, propylene, 1-butene, 1-hexene and 1-octene are preferred.

Examples of the non-conjugated dienes usable in said copolymer rubber include chain non-conjugated dienes such as 1,4-hexadiene, 1,6-octadiene, 2-methyl-1,5-hexadiene, 6-methyl-1,5-heptadiene and 7-methyl-1,6-octadiene; and cyclic non-conjugated dienes such as cyclohexadiene, dicyclopentadiene, methyltetrahydroindene, 5-vinyl norbornene, 5-ethylidene-2-norbornene, 5-methylene-2-norbornene, 5-isopropylidene-2-norbornene and 6-chloromethyl-5-isopropenyl-2-norbornene. Of these non-conjugated dienes, 5-ethylidene-2-norbornene and dicyclopentadiene are preferred.

These non-conjugated dienes may be used in combination with a triene such as 2,3-diisopropylidene-5-norbornene, 2-ethylidene-3-isopropylidene-5-norbornene, 2-propenyl-2,2-norbornadiene, 1,3,7-octatriene and 1,4,9-decatriene. In case of using such a combination, the copolymer rubber becomes an ethylene-α-olefin-non-conjugated diene-non-conjugated triene copolymer rubber.

Examples of the ethylene-α-olefin-non-conjugated diene copolymer rubbers serving as the components (A1) and (B1) in the present invention are ethylene-propylene-5-ethylidene-2-norbornene copolymer rubber, ethylene-propylene-1-butene-5-ethylidene-2-norbornene copolymer rubber, ethylene-1-hexene-5-ethylidene-2- norbornene copolymer rubber, ethylene-1-octene-5-ethylidene-2-norbornene copolymer rubber, ethylene-propylene-dicyclopentadiene copolymer rubber, and ethylene-1-butene-dicyclopenadiene copolymer rubber. Ethylene-1-butene-dicyclopentadiene copolymer rubber is preferred.

The content of ethylene units in the component (A1) is usually 30 to 90% by weight, preferably 35 to 80% by weight, more preferably 40 to 70% by weight, and the content of α-olefin units is usually 10 to 70% by weight, preferably 20 to 65% by weight, more preferably 30 to 60% by weight. (Here, the total of ethylene units and α-olefin units is taken as 100% by weight.) When the term “ethylene unit” is used in the present invention, it means the unit of the polymerized monomer. If the content of the ethylene units exceeds 70% by weight or is less than 10% by weight, the produced thermoplastic elastomer composition may decline in low-temperature strength.

The content of the ethylene units in the component (B1) is 0.50 to 0.95 time, preferably 0.60 to 0.90 time that of the component (A1), and the content of the α-olefin units is equal to the remainder of the subtraction of % by weight of the ethylene unit content from 100% by weight. (The total of ethylene units and α-olefin units is taken as 100% by weight.) If the content of ethylene units is less than 0.5 time or exceeds 0.95 time that of the component (A1), the produced thermoplastic elastomer composition may lower in low-temperature strength.

The content of the non-conjugated diene units in the component (A1) (in case of using a combination of a non-conjugated diene and a non-conjugated triene, the combined content of the units of both monomers) is 0.1 to 40, preferably 0.1 to 30, more preferably 1 to 30, calculated in terms of iodine value of the ethylene-α-olefin-non-conjugated diene copolymer rubber (not oil-extended rubber), in view of durability, heat resistance, low-temperature strength and fluidity of the produced thermoplastic elastomer composition. If the iodine value is less than 0.1, shear rate dependency of viscosity of the produced thermoplastic elastomer composition may be weakened, resulting in deterioration of fluidity. If the iodine value exceeds 30, low-temperature strength of the produced thermoplastic elastomer composition may fall.

The content of the non-conjugated diene units in the component (B1) (in case of using a combination of a non-conjugated diene and a non-conjugated triene, the total content of the units of both monomers) is 0.1 to 40, preferably 0.1 to 30, more preferably 1 to 30, calculated in terms of iodine value of the ethylene-α-olefin-non-conjugated diene copolymer rubber (not oil-extended rubber) in the component (B1), in view of durability, heat resistance, low-temperature strength and fluidity of the produced thermoplastic elastomer composition. If the iodine value is less than 0.1, shear rate dependency of viscosity of the produced thermoplastic elastomer composition may weaken resulting in reduced fluidity. On the other hand, if the iodine value exceeds 30, low-temperature strength of the produced thermoplastic elastomer composition may lower.

The density of the components (A1) and (B1) in the compositions of the present invention, determined according to JIS K7112 without annealing, is 850 to 900 kg/m³, preferably 850 to 890 kg/m³, more preferably 850 to 880 kg/m³. If the density exceeds 900 kg/m³, low-temperature strength of the produced thermoplastic elastomer composition may decline. If the density is less than 850 kg/m³, high-temperature strength of the produced thermoplastic elastomer composition may be harmed.

The Mooney viscosity (ML₁₊₄(100° C.)) of the components (A1) and (B1), measured at 100° C. according to JIS K6300, is 30 to 150, preferably 40 to 100, more preferably 50 to 80. A higher Mooney viscosity than 150 may lead to a decline of fluidity of the produced thermoplastic elastomer composition or deterioration of visual appearance of the moldings of the said composition. A lower Mooney viscosity than 30 may cause a reduction of low-temperature strength of the produced thermoplastic elastomer composition.

The component (C) is a propylene homopolymer having a propylene unit content of more than 50% but 100% or less by weight and a melting point of 100° C. or higher as measured according to JIS K7121 under the condition that both temperature-raising rate and temperature-falling rate are 5° C./min, or a random or block copolymer of propylene, ethylene and/or an α-olefin with a carbon number of 4 to 10, said copolymer having a melting point of 100° C. or higher. The component (C) may be a combination of two or more of said homopolymer, random copolymer and block copolymer.

As the said random copolymer, in view of enhancement of heat resistance of the produced thermoplastic elastomer composition, it is preferable to use (1) a propylene-ethylene random copolymer having a propylene unit content of 90 to 99.5% by weight and an ethylene unit content of 0.5 to 10% by weight (the total of propylene units and ethylene units being taken as 100% by weight), (2) a propylene-ethylene-α-olefin random copolymer having a propylene unit content of 90 to 99% by weight, an ethylene unit content of 0.5 to 9.5% by weight and a C₄-C₁₀ α-olefin unit content of 0.5 to 9.5% by weight (the total of propylene units, ethylene units and α-olefin units being taken as 100% by weight), or (3) a propylene-α-olefin random copolymer having a propylene unit content of 90 to 99.5% by weight and a C₄-C₁₀ α-olefin unit content of 0.5 to 10% by weight (the total of propylene units and α-olefin units being taken as 100% by weight).

The said block copolymer is a mixture of a first polymer and a second polymer produced from a process comprising the step (1) of producing the first polymer which is a propylene homopolymer or a random copolymer of propylene, ethylene and/or an α-olefin, and the step (2) of producing the second polymer which is a random copolymer of propylene, ethylene and/or an α-olefin in the presence of the first polymer, wherein the content of the monomer units other than propylene units contained in the second polymer (viz. the content of ethylene units, the content of α-olefin units or the content of both ethylene units and α-olefin units) is higher than the content of the monomer units other than propylene units contained in the first polymer. Since the step (1) and the step (2) are carried out successively, the above product is usually called a block copolymer in the art, but it is not a typical block copolymer such as expressed by a pattern BBB - - - BBBSSS - - - SSS (BBB - - - BBB indicating a chain of butadiene units and SSS - - - SSS indicating a chain of styrene units) as shown in a textbook relating to polymers. That is, it is not a block copolymer in which the terminal of the first polymer and the terminal of the second polymer are covalently bonded.

In view of enhancement of heat resistance of the produced thermoplastic elastomer composition, the said block copolymer is preferably a copolymer in which the content of the monomer units other than propylene units in the first polymer is 0.5 to 10% by weight (letting the total of all the monomer units contained in the first polymer be 100% by weight), more preferably a copolymer in which the content of the monomer units other than propylene units in the second polymer is 5 to 50% by weight (letting the total of all the monomer units contained in the second polymer be 100% by weight), even more preferably a copolymer in which the content of the second polymer is 5 to 70% by weight (taking the amount of said block copolymer as 100% by weight).

Examples of the said C₄-C₁₀ α-olefins include linear α-olefins such as 1-butene, 1-pentene, 1-hexene, 1-octene and 1-decene; branched α-olefins such as 3-methyl-1-butene and 3-methyl-1-pentene; and combinations of two or more of these olefins. Ethylene is preferred.

The melt flow rate of the component (C), as measured according to JIS K7210 at 230° C. under a load of 21.18 N, is preferably 0.1 g/10 min or above, more preferably 1 g/10 min or above, in view of enhancement of visual appearance of the moldings of the produced thermoplastic elastomer composition, but it should be preferably not higher than 150 g/10 min, more preferably not higher than 100 g/10 min, for raising low-temperature strength of the produced thermoplastic elastomer composition.

As the component (C), there can be used, for example, propylene homopolymer, ethylene-propylene random copolymer, ethylene-propylene-butene random copolymer, ethylene-propylene block copolymer, and ethylene-propylene-butene block copolymer. Particularly propylene homopolymer, ethylene-propylene random copolymer and ethylene-propylene block copolymer are preferred.

The content of the component (A1) is 15 to 40% by weight, preferably 20 to 35% by weight, more preferably 25 to 35% by weight, the content of the component (B1) is 15 to 40% by weight, preferably 20 to 35% by weight, more preferably 25 to 35% by weight, and the content of the component (C) is 20 to 70% by weight, preferably 30 to 60% by weight, more preferably 30 to 50% by weight (letting (A1)+(B1)+(C)=100% by weight).

If the content of the component (A1) or (B1) is less than 15% by weight, the produced thermoplastic elastomer composition may prove low in low-temperature strength. Also, if the content of either the component (A1) or the component (B1) exceeds 40% by weight, the produced thermoplastic elastomer composition may lower in fluidity or the molded products of the produced thermoplastic elastomer composition may suffer deterioration of visual appearance.

The thermoplastic elastomer composition of the present invention may be a composition obtained from a dynamic heat treatment conducted on the component materials in the presence of a crosslinking agent.

As examples of the crosslinking agents usable here, organic peroxides, sulfur compounds and alkylphenol resins can be cited, of which organic peroxides are preferred.

Examples of the organic peroxides include ketone peroxides, diacyl peroxides, hydroperoxides, dialkyl peroxides, peroxyketals, alkyl peresters, percarbonates, peroxydicarbonates, and peroxy esters. The more concrete examples of such organic peroxides are: dicumyl peroxide, 2,5-dimethyl-2,5-di(t-butylperoxy)hexane, 2,5-dimethyl-2,5-di(t-butylperoxy)hexine, 1,3-bis(t-butylperoxyisopropyl)benzene, t-butylcumyl peroxide, di-t-butyl peroxide, 2,2,4-trimethylpentyl-2-hydroperoxide, diisopropyl benzohydroperoxide, cumene peroxide, t-butyl peroxide, 1,1-di(t-butylperoxy)-3,5,5-trimethylcyclohexane, 1,1-di-t-butylperoxycyclohexane, isobutyl peroxide, 2,4-dichlorobenzoyl peroxide, o-methylbenzoyl peroxide, bis-3,5,5-trimethylhexanoyl peroxide, lauroyl peroxide, benzoyl peroxide and p-chlorobenzoyl peroxide; and combinations of two or more of these compounds.

The amount of the crosslinking agent used in the above treatment is usually 0.01 to 10 parts by weight, preferably 0.05 to 2 parts by weight, more preferably 0.1 to 1 part by weight, where the total of the components (A1), (B1) and (C) is taken as 100 parts by weight. If the amount of the crosslinking agent is less than 0.01 part by weight, the produced thermoplastic elastomer composition may turn out low in fluidity, and if its amount exceeds 10 parts by weight, then low-temperature strength of the produced composition may deteriorate.

The crosslinking agent may be used in combination with a crosslinking assistant for improving low-temperature strength of the produced thermoplastic elastomer composition. The preferred crosslinking assistants are the compounds having two or more double bonds. Exemplary of such crosslinking assistants are N,N-m-phenylenebismaleimide, toluylenebismaleimide, p-quinonedioxime, nitrosobenzene, diphenylguanidine, trimethylolpropane, trimethylolpropane trimethacrylate, and divinylbenzene; and combinations of two or more of these compounds.

The amount of the crosslinking assistant used is preferably 0.01 to 10 parts by weight where the total of the components (A1), (B) and (C) is taken as 100 parts by weight. If the amount of the crosslinking assistant is less than 0.01 part by weight, the produced thermoplastic elastomer composition may be unsatisfactory in low-temperature strength, and if its amount exceeds 10 parts by weight, there may not be obtained the desired effect of improving low-temperature strength of the produced composition.

Any of the components (A1), (B1) and (C) may be incorporated with an additive or additives such as inorganic filler (e.g. talc, calcium carbonate and calcined kaolin), organic filler (e.g. fiber, woodmeal and cellulose powder), antioxidant (e.g. phenol type, sulfur type, phosphorus type, lactone type and vitamin type), weathering agent, ultraviolet absorber (e.g. benzotriazole type, tridiamine type, anilide type and benzophenone type), heat stabilizer, light stabilizer (e.g. hindered amine type and benzoate type), antistatic agent, nucleating agent, pigment, adsorbent (e.g. metal oxides such as zinc oxide and magnesium oxide), metal chlorides (e.g. iron chloride and calcium chloride), hydrotalcite, and aluminate. These additives may be blended with the produced thermoplastic elastomer composition.

When molding is carried out with the said thermoplastic elastomer composition, it may be combined with a lubricant or a silicone compound for improving releasability from the mold and wear and flaw resistance of the molded product. As the lubricant, there can be used, for instance, lauric acid amide, palmitic acid amide, stearic acid amide, oleic acid amide, erucic acid amide, methylenebisstearic acid amide, ethylenebisstearic acid amide, ethylenebisoleic acid amide, stearyldiethanol amide, and combinations of two or more of these compounds. Stearic acid amide, oleic acid amide and erucic acid amide are preferred.

A lubricant is added in an amount of preferably 0.01 to 10 parts by weight, more preferably 0.05 to 1 part by weight, with the total of the components (A1), (B1) and (C) being taken as 100 parts by weight, in view of mold releasability and wear and flaw resistance of the moldings. If the lubricant amount is less than 0.01 part by weight, the said properties may be adversely affected, while addition of the lubricant in excess of 10 parts by weight may cause precipitation of the lubricant on the surface of the molding of the produced thermoplastic elastomer composition.

Examples of the silicone compounds usable in the present invention include straight silicones such as dimethyl silicone, methylphenyl silicone and methylhydrodiene silicone; and modified silicones such as amino-modified silicones, epoxy-modified silicones, carboxy-modified silicones, carbinol-modified silicones, methacryl-modified silicones, mercapto-modified silicones, phenol-modified silicones, polyether-modified silicones, methylstyryl-modified silicones, alkyl-modified silicones, higher fatty acid ester-modified silicones, higher alkoxyl-modified silicones, and fluorine-modified silicones. Of these silicone compounds, straight silicones are preferred. These silicone compounds may be commercial products. They may also be a masterbatch having a silicone oil and/or a silicone rubber packed densely beforehand in an olefin resin.

The amount of the silicone compound added, in view of mold releasability and wear and flaw resistance of the moldings, is preferably 0.01 to 10 parts by weight, more preferably 0.1 to 5 parts by weight, with the total of the components (A1), (B1) and (C) being taken as 100 parts by weight. If its amount is less than 0.01 part by weight, the said properties may be adversely affected, while addition of this compound in excess of 10 parts by weight may cause discoloration on the surface of the moldings of the produced thermoplastic elastomer composition.

Now, the second embodiment of the present invention is explained.

The thermoplastic elastomer composition in the second embodiment of the present invention comprises at least the following three components: (A2) an ethylene-α-olefin-non-conjugated diene copolymer rubber having a density of 850 to 900 kg/m³, a Mooney viscosity (ML₁₊₄(100° C.)) of 30 to 150, an ethylene unit content of 30 to 90 and an iodine value of 0.1 to 40; (B2) an ethylene-α-olefin-non-conjugated diene copolymer rubber having a density of 850 to 900 kg/m³, a Mooney viscosity (ML₁₊₄(100° C.)) of 30 to 150, an ethylene unit content of 30 to 90, and an iodine value which is 0.25 to 0.95 time that of the component (A2); and (C) a polypropylene resin.

As the ethylene-α-olefin-non-conjugated diene copolymer rubbers serving as the components (A2) and (B2) according to the present invention, it is possible to use a mixture of a softening agent (which is also called “extender oil”) and an ethylene-α-olefin-non-conjugated diene copolymer rubber, that is, a softening agent-extended ethylene-α-olefin-non-conjugated diene copolymer rubber. For mixing an ethylene-α-olefin-non-conjugated diene copolymer rubber and a softening agent, there are available, for instance, the following methods: (1) an ethylene-α-olefin-non-conjugated diene copolymer rubber as a finished product (which may be a commercial product) and a softening agent are mixed by a known mixing machine; (2) a solution of the intermediate in the production of an ethylene-α-olefin-non-conjugated diene copolymer rubber is mixed with a softening agent to form a mixture, and then the solvent is removed from this mixture.

Examples of the softening agents usable in the present invention include mineral oils such as paraffinic mineral oils, naphthenic mineral oils and aromatic mineral oils. Use of a paraffinic mineral oil is preferred. In case of mixing a softening agent, its amount needs to be regulated so that the Mooeny viscosity (ML₁₊₄(100° C.)) of the ethylene-α-olefin-non-conjugated diene copolymer rubber after addition of the softening agent will fall in the range of 30 to 150. Such regulated amount of the softening agent is usually 20 to 200 parts by weight, preferably 20 to 150 parts by weight, more preferably 20 to 120 parts by weight, per 100 parts by weight of the ethylene-α-olefin-non-conjugated diene copolymer rubber which does not contain the softening agent. If the content of the softening agent is less than 20 parts by weight, fluidity of the produced thermoplastic elastomer composition may deteriorate, and if its content exceeds 200 parts by weight, the produced composition may lower in its low-temperature strength.

The α-olefin in the said copolymer rubber is usually one with a carbon number of 3 to 10. Examples of such α-olefins are linear α-olefins such as propylene, 1-butene, 1-pentene, 1-hexene, 1-octene and 1-decene; and branched α-olefins such as 3-methyl-1-butene and 3-methyl-1-pentene. Of these α-olefins, propylene, 1-butene, 1-hexene and 1-octene are preferred.

Examples of the non-conjugated dienes in the said copolymer rubber are chain non-conjugated dienes such as 1,4-hexadiene, 1,6-octadiene, 2-methyl-1,5-hexadiene, 6-methyl-1,5-heptadiene and 7-methyl-1,6-octadiene; and cyclic non-conjugated dienes such as cyclohexadiene, dicyclopentadiene, methyltetrahydroindene, 5-vinyl norbornene, 5-ethylidene-2-norbornene, 5-methylene-2-norbornene, 5-isopropylidene-2-norbornene and 6-chloromethyl-5-isopropenyl-2-norbornene. Of these non-conjugated dienes, 5-ethylidene-2-norbornene and dicyclopentadiene are preferred.

These non-conjugated dienes may be used in combination with a triene such as 2,3-diisopropylidene-5-norbornene, 2-ethylidene-3-isopropylidene-5-norbornene, 2-propenyl-2,2-norbornene, 1,3,7-octatriene and 1,4,9-decatriene. In case of using such combinations, the copolymer rubber becomes an ethylene-α-olefin-non-conjugated diene-non-conjugated triene copolymer rubber.

Examples of the ethylene-α-olefin-non-conjugated diene copolymer rubbers serving as the components (A2) and (B2) in the present invention are ethylene-propylene-5-ethylidene-2-norbornene copolymer rubber, ethylene-propylene-1-butene-5-ethylidene-2-norbornene copolymer rubber, ethylene-1-hexene-5-ethylidene-2-norbornene copolymer rubber, ethylene-1-octene-5-ethylidene-2-norbornene copolymer rubber, ethylene-propylene-dicyclopentadiene copolymer rubber, and ethylene-1-butene-dicyclopentadiene copolymer rubber. Ethylene-1-butene-dicyclopentadiene copolymer rubber is preferred.

The content of the ethylene units in the component (A2) is usually 30 to 90% by weight, preferably 35 to 80% by weight, more preferably 40 to 70% by weight, and the content of the α-olefin units is usually 10 to 70% by weight, preferably 20 to 65% by weight, more preferably 30 to 60% by weight (taking the total of the ethylene units and the α-olefin units as 100% by weight). If the content of the α-olefin is less than 10% by weight or exceeds 70% by weight, the produced thermoplastic elastomer composition may deteriorate in low-temperature strength.

The content of the ethylene units in the component (B2) is usually 30 to 90% by weight, preferably 35 to 80% by weight, more preferably 40 to 70% by weight, and the content of the α-olefin units is usually 10 to 70% by weight, preferably 20 to 65%, by weight, more preferably 30 to 60% by weight (taking the total of the ethylene units and the α-olefin units as 100% by weight). If the content of the α-olefin units is less than 10% by weight or exceeds 70% by weight, the produced thermoplastic elastomer composition may deteriorate in low-temperature strength.

The content of the non-conjugated diene units in the component (A2) (in case of using a combination of a non-conjugated diene and a non-conjugated triene, the total content of both monomer units) is 0.1 to 40, preferably 0.1 to 30, more preferably 1 to 30, calculated in terms of iodine value of the ethylene-α-olefin-non-conjugated diene copolymer rubber (not oil-extended rubber) of the component (A2), in view of durability, heat resistance, low-temperature strength and fluidity of the produced thermoplastic elastomer composition. If the iodine value is less than 0.1, shear rate dependency of viscosity of the produced thermoplastic elastomer composition may weaken, resulting in a reduced fluidity. If the iodine value exceeds 30, low-temperature strength of the produced composition may lower.

The content of the non-conjugated diene units in the component (B2) (in case of using a combination of a non-conjugated diene and a non-conjugated triene, the total content of both monomer units) is 0.25 to 0.95 time, preferably 0.30 to 0.80 time that of the component (A2), calculated in terms of the iodine value of the ethylene-α-olefin-non-conjugated diene copolymer rubber (not oil-extended rubber) of the component (B2). If the content of the non-conjugated diene units, calculated in terms of iodine value, is less than 0.25 time or exceeds 0.95 time that of the component (A2), the produced thermoplastic elastomer composition may decline in low-temperature strength.

The density of the components (A2) and (B2) in the compositions according to the present invention, as determined according to JIS K7112 without annealing, is 850 to 900 kg/m³, preferably 850 to 890 kg/m³, more preferably 850 to 880 kg/m³. If the density exceeds 900 kg/m³, the produced thermoplastic elastomer composition may lessen in low-temperature strength, and if it is less than 850 kg/m³, the produced composition may lower in high-temperature strength.

The Mooney viscosity (ML₁₊₄(100° C.)) of the components (A2) and (B2) in the compositions according to the present invention, as measured at 100° C. according to JIS K6300, is 30 to 150, preferably 40 to 100, more preferably 50 to 80. If the Mooney viscosity exceeds 150, the produced composition may be adversely affected in its fluidity and/or the moldings of the composition may suffer a deterioration of visual appearance. If the Mooney viscosity is less than 30, the produced composition may prove low in low-temperature strength.

The component (C) is a propylene homopolymer having a propylene unit content of more than 50% but 100% or less by weight and a melting point of 100° C. or higher as measured according to JIS K7121 at a temperature-raising or temperature-lowering rate of 5° C./min, or a propylene, ethylene and/or C₄-C₁₀ α-olefin random or block copolymer having a melting point of 100° C. or higher. The component (C) may be a combination of two or more of said homopolymer, random copolymer and block copolymer.

The said random copolymer, for the reason of enhancing heat resistance of the produced composition, is preferably (1) a propylene-ethylene random copolymer having a propylene unit content of 90 to 99.5% by weight and an ethylene unit content of 0.5 to 10% by weight (taking the total of propylene units and ethylene units as 100% by weight); (2) a propylene-ethylene-α-olefin random copolymer having a propylene unit content of 90 to 99% by weight, an ethylene unit content of 0.5 to 9.5% by weight and a C₄-C₁₀ α-olefin unit content of 0.5 to 9.5% by weight (taking the total of propylene units, ethylene units and α-olefin units as 100% by weight); or (3) a propylene-α-olefin random copolymer having a propylene unit content of 90 to 99.5% by weight and a C₄-C₁₀ α-olefin unit content of 0.5 to 10% by weight (taking the total of propylene units and α-olefin units as 100% by weight).

The said block copolymer is a mixture of a first polymer and a second polymer produced from a process comprising a step (1) of producing the first polymer which is a propylene homopolymer or a propylene, ethylene and/or an α-olefin random copolymer, and a step (2) of producing the second polymer which is a propylene, ethylene and/or an α-olefin random copolymer in the presence of the first polymer, wherein the content of the monomer units other than propylene units contained in the second polymer (viz. the content of ethylene units, the content of α-olefin units or the content of both ethylene units and α-olefin units) is higher than the content of the monomer units other than propylene units contained in the first polymer. Since the step (1) and the step (2) are carried out successively, the above product is usually called a block copolymer in the art, but it is not a typical block copolymer such as expressed by a pattern BBB - - - BBBSSS - - - SSS (BBB - - - BBB indicating a chain of butadiene units and SSS - - - SSS indicating a chain of styrene units) as shown in a textbook relating to polymers. That is, it is not a block copolymer in which the terminal of the first polymer and the terminal of the second polymer are covalently bonded.

In view of enhancement of heat resistance of the produced thermoplastic elastomer composition, the said block copolymer is preferably a copolymer in which the content of the monomer units other than propylene units contained in the first polymer is 0.5 to 10% by weight (letting the total of all the monomer units contained in the first polymer be 100% by weight), more preferably a copolymer in which the content of the monomer units other than propylene units contained in the second polymer is 5 to 50% by weight (letting the total of all the monomer units contained in the second polymer be 100% by weight), even more preferably a copolymer in which the content of the second polymer is 5 to 70% by weight (letting the amount of said block copolymer be 100% by weight).

Examples of the said C₄-C₁₀ α-olefins are linear α-olefins such as 1-butene, 1-pentene, 1-hexene, 1-octene and 1-decene; branched α-olefins such as 3-methyl-1-butene and 3-methyl-1-pentene; and combinations of two or more of these olefins. Ethylene is preferred.

The melt flow rate of the component (C), measured according to JIS K7210 at 230° C. under a load of 21.18 N, is preferably 0.1 g/10 min or above, more preferably 1 g/10 min or above, in view of enhancement of visual appearance of the moldings of the produced thermoplastic elastomer composition, but it should be preferably not higher than 150 g/10 min, more preferably not higher than 100 g/10 min, for raising low-temperature strength of the produced thermoplastic elastomer composition.

As the component (C), there can be used, for example, propylene homopolymer, ethylene-propylene random copolymer, ethylene-propylene-butene random copolymer, ethylene-propylene block copolymer, and ethylene-propylene-butene block copolymer. Particularly propylene homopolymer, ethylene-propylene random copolymer and ethylene-propylene block copolymer are preferred.

The content of the component (A2) is 15 to 40% by weight, preferably 20 to 35% by weight, more preferably 25 to 35% by weight, the content of the component (B2) is 15 to 40% by weight, preferably 20 to 35% by weight, more preferably 25 to 35% by weight, and the content of the component (C) is 20 to 70% by weight, preferably 30 to 60% by weight, more preferably 30 to 50% by weight (letting (A2)+(B2)+(C)=100% by weight).

If the content of the component (A2) or (B2) is less than 15% by weight, the produced thermoplastic elastomer composition may prove low in low-temperature strength. Also, if the content of either the component (A2) or the component (B2) exceeds 40% by weight, the produced thermoplastic elastomer composition may lower in fluidity or the molded products of the produced thermoplastic elastomer composition may suffer deterioration in visual appearance.

The thermoplastic elastomer composition of the present invention may be a composition obtained from a dynamic heat treatment conducted on the component materials in the presence of a crosslinking agent.

As examples of the crosslinking agents usable here, organic peroxides, sulfur compounds and alkylphenol resins can be cited, of which organic peroxides are preferred.

Examples of the organic peroxides include ketone peroxides, diacyl peroxides, hydroperoxides, dialkyl peroxides, peroxyketals, alkyl peresters, percarbonates, peroxy dicarbonates, and peroxy esters. The more concrete examples of such organic peroxides are: dicumyl peroxide, 2,5-dimethyl-2,5-di(t-butylperoxy)hexane, 2,5-dimethyl-2,5-di(t-butylperoxy)hexine, 1,3-bis(t-butylperoxyisopropyl)benzene, t-butylcumyl peroxide, di-t-butyl peroxide, 2,2,4-trimethylpentyl-2-hydroperoxide, diisopropyl benzohydroperoxide, cumene peroxide, t-butyl peroxide, 1,1-di(t-butylperoxy)-3,5,5-trimethylcyclohexane, 1,1-di-t-butylperoxycyclohexane, isobutyl peroxide, 2,4-dichlorobenzoyl peroxide, o-methylbenzoyl peroxide, bis-3,5,5-trimethylhexanoyl peroxide, lauroyl peroxide, benzoyl peroxide, and p-chlorobenzoyl peroxide; and combinations of two or more of these compounds.

The amount of the crosslinking agent used in the above treatment is usually 0.01 to 10 parts by weight, preferably 0.05 to 2 parts by weight, more preferably 0.1 to 1 part by weight, where the total of the amounts of the components (A2), (B2) and (C) is taken as 100 parts by weight. If the amount of the crosslinking agent is less than 0.01 part by weight, the produced thermoplastic elastomer composition may turn out low in fluidity, and if its amount exceeds 10 parts by weight, then low-temperature strength of the produced composition may deteriorate.

The crosslinking agent may be used in combination with a crosslinking assistant for improving low-temperature strength of the produced thermoplastic elastomer composition. The preferred crosslinking assistants are the compounds having two or more double bonds. Exemplary of such crosslinking assistants are N,N-m-phenylenebismaleimide, toluylenebismaleimide, p-quinonedioxime, nitrosobenzene, diphenylguanidine, trimethylolpropane, trimethylolpropane trimethacrylate, divinylbenzene, and combinations of two or more of these compounds.

The amount of the crosslinking assistant used is preferably 0.01 to 10 parts by weight where the total of the components (A2), (B2) and (C) is taken as 100 parts by weight. If the amount of the crosslinking assistant is less than 0.01 part by weight, the produced thermoplastic elastomer composition may be unsatisfactory in low-temperature strength, and if its amount exceeds 10 parts by weight, there may not be obtained the desired effect of improving low-temperature strength of the produced composition.

When molding is carried out with the said thermoplastic elastomer composition, it may be combined with a lubricant or a silicone compound for improving releasability of the molded product from the mold and wear and flaw resistance of the molded product. As the lubricant, there can be used, for instance, lauric acid amide, palmitic acid amide, stearic acid amide, oleic acid amide, erucic acid amide, methylenebisstearic acid amide, ethylenebisstearic acid amide, ethylenebisoleic acid amide, stearyldiethanol amide, and combinations of two or more of these compounds. Stearic acid amide, oleic acid amide and erucic acid amide are preferred.

A lubricant is added in an amount of preferably 0.01 to 10 parts by weight, more preferably 0.05 to 1 part by weight (letting (A2)+(B2)+(C)=100 parts by weight), in view of mold releasability and wear and flaw resistance of the moldings. If the lubricant amount is less than 0.01 part by weight, the said properties may be adversely affected, while addition of the lubricant in excess of 10 parts by weight may cause precipitation of the lubricant on the surface of the molding of the produced thermoplastic elastomer composition.

Examples of the silicone compounds usable in the present invention include straight silicones such as dimethyl silicone, methylphenyl silicone and methylhydrodiene silicone; and modified silicones such as amino-modified silicones, epoxy-modified silicones, carboxy-modified silicones, carbinol-modified silicones, methacryl-modified silicones, mercapto-modified silicones, phenol-modified silicones, polyether-modified silicones, methylstyryl-modified silicones, alkyl-modified silicones, higher fatty acid ester-modified silicones, higher alkoxyl-modified silicones, and fluorine-modified silicones. Of these silicone compounds, straight silicones are preferred. These silicone compounds may be commercial products. They may also be a masterbatch having a silicone oil and/or a silicone rubber packed densely beforehand in an olefin resin.

The amount of the silicone compound added, in view of mold releasability and wear and flaw resistance of the moldings, is preferably 0.01 to 10 parts by weight, more preferably 0.1 to 5 parts by weight, taking the total amount of the components (A2), (B2) and (C) as 100 parts by weight. If its amount is less than 0.01 part by weight, the said properties may be adversely affected, while addition of this compound in excess of 10 parts by weight may cause discoloration on the surface of the molding of the produced thermoplastic elastomer composition.

Any of the components (A2), (B2) and (C) may be incorporated with an additive or additives such as inorganic filler (e.g. talc, calcium carbonate and calcined kaolin), organic filler (e.g. fiber, woodmeal and cellulose powder), antioxidant (e.g. phenol type, sulfur type, phosphorus type, lactone type and vitamin type), weathering agent, ultraviolet absorber (e.g. benzotriazole type, tridiamine type, anilide type and benzophenone type), heat stabilizer, light stabilizer (e.g. hindered amine type and benzoate type), antistatic agent, nucleating agent, pigment, adsorbent (e.g. metal oxides such as zinc oxide and magnesium oxide), metal chlorides (e.g. iron chloride and calcium chloride), hydrotalcite, and aluminate. These additives may be blended with the produced thermoplastic elastomer composition.

The known polymerization methods such as slurry polymerization, solution polymerization, bulk polymerization and vapor phase polymerization using a known Ziegler-Natta catalyst or a known complex catalyst such as metallocene type complex and non-metallocene type complex catalyst can be employed for producing the components (A1), (B1), (A2) and (B2) in the present invention.

The components (A1) and (B1) may be produced by mixing ethylene-α-olefin-non-conjugated copolymer rubbers separately obtained by polymerizations, respectively, but it is preferable for allowing a simplification of the thermoplastic elastomer composition production process to use two polymerization reactors connected in series or parallel to each other, to form the component (A1) in one of said polymerization reactor while forming the component (B1) in the other polymerization reactor, to form a mixed solution of the components (A1) and (B1) mixed in a solvent, and then to remove the solvent from the mixed solution to obtain a mixture of the component (A1) and (B1). When using such a mixture of the components (A1) and (B1), a pertinent mixed state can be easily produced when mixed with the component (C) because the components (A1) and (B1) have already been mixed. Particularly in case of carrying out a dynamic heat treatment in the presence of a crosslinking agent, use of such a mixture of the components (A1) and (B1) allows a reduction of mixing time. This also has the advantage of suppressing generation of heat during mixing to enable obtainment of the products with good quality such as fine visual appearance. The same holds true with the case involving the components (A2) and (B2).

For the polymerization of the polypropylene resin used as component (C) in the first and second embodiments of the present invention, it is possible to employ a known polymerization method such as slurry polymerization, solution polymerization, bulk polymerization or vapor phase polymerization using a known Ziegler-Natta catalyst or a known complex catalyst such as metallocene type complex and non-metallocene type complex catalysts. The component (C) may be a commercial product.

The thermoplastic elastomer compositions of the present invention can be obtained by mixing the said components (A1), (B1) and (C), or (A2), (B2) and (C), if necessary with other additive substance(s), by known means such as double-screw extruder or Banbury mixer. Mixing may be conducted in the presence of a crosslinking agent.

The thermoplastic elastomer compositions of the present invention are suited for manufacturing the air bag covers. The air bag cover according to the present invention is produced by molding a thermoplastic elastomer composition of this invention by a known molding method such as injection molding. Particularly the air bag cover obtained by using a thermoplastic elastomer composition with a rigidity of 100 to 400 MPa is well adapted for the driver's seat.

### EXAMPLES

The present invention is further illustrated with reference to the embodiments thereof, which embodiments, however, are not to be construed as limiting the scope of the invention.

### [I] Methods for Determination of Properties

### (1) Rigidity (Stiffness)

Flexural modulus of elasticity was measured according to JIS K7203.

### (2) Low-Temperature Strength

An Izod impact test was conducted at −47° C. according to JIS K6911, and the result was rated as follows:

NB: Not broken

B: Broken

### (3) Fluidity

Flow length was calculated from the length of the molded product obtained from molding conducted under the following conditions using a 2 mm thick elliptical spiral mold.

Flow length=length/thickness

Molding Conditions
Mold temperature: 50° C.
Injection molding machine: Toshiba Machinery IS100-EN
Cylinder temperature: HN=220° C.; H3=220° C.; H2=200° C.; H1=190° C.
Injection pressure: 116 MPa

### (4) Melt Flow Rate (MFR)

Measured according to JIS K7210 at 230° C. under a load of 21.18 N.

### (5) Density

Measured according to JIS K7112 without annealing.

### (6) Mooney Viscosity (ML₁₊₄(100° C.))

Measured according to JIS 6300 under the conditions of 100° C., preheating time of one minute and rotor rotation time of 4 minutes.

### (7) Ethylene Unit Content

Measured by infrared absorption spectroscopy.

### (8) Iodine Value

Measured by infrared absorption spectroscopy

### [II] Materials

### (1) Oil

Idemitsu Kosan's PW-380 was used as oil component contained in the oil-extended ethylene-propylene-5-ethylidene-2-norbornene copolymer rubber in all of the following Examples and Comparative Examples.

### (2) Ethylene-propylene-non-conjugated diene Copolymer Rubbers

### A1-1: Ethylene-propylene-5-ethylidene-2-norbornene Copolymer Rubber

Density: 880 kg/m³; Mooney viscosity (ML₁₊₄(100° C.)): 78; ethylene units: 67 wt %; propylene units: 33 wt % (the total of both ethylene units and propylene units being taken as 100 wt %); iodine value: 3.9; oil content: 40 parts by weight to 100 parts by weight of the copolymer.

### A1-2: Ethylene-propylene-5-ethylidene-2-norbornene Copolymer Rubber

Density: 880 kg/m³; Mooney viscosity (ML₁₊₄(100° C.)): 80; ethylene units: 64 wt %; propylene units: 36 wt % (the total of both ethylene units and propylene units being taken as 100 wt %); iodine value: 3.6; oil content: 40 parts by weight to 100 parts by weight of the copolymer.

### A1-3: Ethylene-propylene-5-ethylidene-2-norbornene Copolymer Rubber

Density: 880 kg/m³; Mooney viscosity (ML₁₊₄(100° C.)): 75; ethylene units: 63 wt %; propylene units: 37 wt % (the total of both ethylene units and propylene units being taken as 100 wt %); iodine value: 3.6; oil content: 40 parts by weight to 100 parts by weight of the copolymer.

### B1-1: Etylene-propylene-5-ethylidene-2-norbornene Copolymer Rubber

Density: 880 kg/m³; Mooney viscosity (ML₁₊₄(100° C.)): 78; ethylene units: 57 wt %; propylene units: 43 wt % (the total of both ethylene units and propylene units being taken as 100 wt %); iodine value: 4.4; oil content: 40 parts by weight to 100 parts by weight of the copolymer.

B1-2: Ethylene-propylene-5-ethylidene-2-norbornene Copolymer rubber Density: 880 kg/m³; Mooney viscosity (ML₁₊₄(100° C.)): 80; ethylene units: 51 wt %; propylene units: 49 wt % (the total of both ethylene units and propylene units being taken as 100 wt %); iodine value: 3.9; oil content: 40 parts by weight to 100 parts by weight of the copolymer.

### B1-3: Ethylene-propylene-5-ethylidene-2-norbornene Copolymer Rubber

Density: 880 kg/M³; Mooney viscosity (ML₁₊₄(100° C.)): 75; ethylene units: 63 wt %; propylene units: 37 wt % (the total of both ethylene units and propylene units being taken as 100 wt %); iodine value: 3.6: oil content: 40 parts by weight to 100 parts by weight of the copolymer.

### A2-1: Ethylene-propylene-5-ethylidene-2-norbornene Copolymer Rubber

Density: 880 kg/m³; Mooney viscosity (ML₁₊₄(100° C.)): 76; ethylene units: 62 wt %; propylene units: 38 wt % (the total of both ethylene units and propylene units being taken as 100 wt %); iodine value: 7.4; oil content: 40 parts by weight to 100 parts by weight of the copolymer.

### A2-2: Ethylene-propylene-5-ethylidene-2-norbornene Copolymer Rubber

Density: 880 kg/m³; Mooney viscosity (ML₁₊₄(100° C.)): 80; ethylene unit content: 63 wt %; propylene unit content: 37 wt % (the total of both ethylene units and propylene units being taken as 100 wt %); iodine value: 4.9; oil content: 40 parts by weight to 100 parts by weight of the copolymer.

### A2-3: Ethylene-propylene-5-ethylidene-2-norbornene Copolymer Rubber

Density: 880 kg/m³; Mooney viscosity (ML₁₊₄(100° C.)): 75; ethylene units: 63 wt %; propylene units: 37 wt % (taking the total of both ethylene units and propylene units as 100 wt %); iodine value: 3.6; oil content: 40 parts by weight to 100 parts by weight of the copolymer.

### B2-1: Ethylene-propylene-5-ethylidene-2-norbornene Copolymer Rubber

Density: 880 kg/m³; Mooney viscosity (ML₁₊₄(100° C.)): 76; ethylene units: 62 wt %; propylene units: 38 wt % (taking the total of both ethylene units and propylene units as 100 wt %); iodine value: 2.6; oil content: 40 parts by weight to 100 parts by weight of the copolymer.

### B2-2: Ethylene-propylene-5-ethylidene-2-norbornene Copolymer Rubber

Density: 880 kg/m³; Mooney viscosity (ML₁₊₄(100° C.)): 80; ethylene units: 63 wt %; propylene units: 37 wt % (taking the total of both ethylene units and propylene units as 100 wt %); iodine value: 2.7; oil content: 40 parts by weight to 100 parts by weight of the copolymer.

### B2-3: Ethylene-propylene-5-ethylidene-2-norbornene Copolymer Rubber

Density: 880 kg/m³; Mooney viscosity (ML₁₊₄(100° C.)): 75; ethylene unit content: 63 wt %; propylene unit content: 37 wt % (taking the total of both ethylene units and propylene units as 100 wt %); iodine value: 3.6: oil content: 40 parts by weight to 100 parts by weight of the copolymer.

### AB-1: Ethylene-propylene-5-ethylidene-2-norbornene Copolymer Rubber

Using two polymerization reactors connected in series to each other, an ethylene-propylene-5-ethylidene-2-norbornene copolymer rubber was formed by a polymerization in the first polymerization reactor and sent to the next polymerization reactor where an ethylene-propylene-5-ethylidene-2-norbornene copolymer of a structure different from that of the copolymer formed in the first polymerization reactor was formed by a polymerization, to produce a mixture of the ethylene-propylene-5-ethylidene-2-norbornene copolymers differing in structure. To 100 parts by weight of the ethylene-propylene-5-ethylidene-2-norbornene copolymer discharged from the second-stage polymerization reactor, 40 parts by weight of an oil was added, and after mixing them homogeneously, the solvent and the unreacted monomers were removed to obtain an ethylene-propylene-5-ethylidene-2-norbornene copolymer rubber.

Ethylene-propylene-5-ethylidene-2-norbornene copolymer rubber as a mixture:
Ethylene units: 61 wt %; propylene units: 39 wt % (taking the total of both ethylene units and propylene units as 100 wt %); iodine value: 4.2; oil content: 40 parts by weight to 100 parts by weight of the copolymer; density (in the oil-containing state): 880 kg/m³; Mooney viscosity (ML₁₊₄(100° C.)) (in the oil-containing state): 78.

Ethylene-propylene-5-ethylidene-2-norbornene copolymer rubber formed in the first polymerization reactor:
Ethylene units: 57 wt %; propylene units: 43 wt % (taking the total of both ethylene units and propylene units as 100 wt %); iodine value: 4.4; density (in a state of containing 40 parts by weight of oil to 100 parts by weight of the ethylene-propylene-5-ethylidene-2-norbornene copolymer): 880 kg/m³; Mooney Viscosity (ML₁₊₄(100° C.)) (in the same state): 78.

Ethylene-propylene-5-ethylidene-2-norbornene copolymer rubber formed in the second polymerization reactor:
Ethylene units: 67 wt %; propylene units: 33 wt % (taking the total of ethylene units and propylene units as 100 wt %); iodine value: 3.9; density (in a state of containing 40 parts by weight of oil to 100 parts by weight of the ethylene-propylene-5-ethylidene-2-norbornene copolymer): 880 kg/m³; Mooney viscosity (ML₁₊₄(100° C.)) (in the said state): 78.

The weight ratio of the amount of the monomers reacted in the first polymerization reactor to that in the second polymerization reactor was 2 to 1. The structure of the copolymer formed in the second polymerization reactor was determined by calculations from the structure of the copolymer mixture obtained at the outlet of the second polymerization reactor, the structure of the copolymer obtained at the outlet of the first polymerization reactor and the ratio of the amounts of the monomers reacted in the respective polymerization reactors.

### AB-2: Ethylene-propylene-5-ethylidene-2-norbornene Copolymer Rubber

The same procedure as used for AB-1 was conducted using two series-connected polymerization reactors to produce a mixture of ethylene-propylene-5-ethylidene-2-norbornene copolymer rubbers differing in structure.

Ethylene-propylene-5-ethylidene-2-norbornene copolymer rubber as a mixture:
Ethylene units: 62 wt %; propylene units: 38 wt % (taking the total of ethylene units and propylene units as 100 wt %); iodine value: 4.2; oil content: 40 parts by weight to 100 parts by weight of the ethylene-propylene-5-ethylidene-2-norbornene copolymer; density (in an oil-containing state): 880 kg/m³; Mooney viscosity (ML₁₊₄(100° C.)) (in an oil-containing state): 76.
Ethylene-propylene-5-ethylidene-2-norbornene copolymer rubber formed in the first polymerization reactor:
Ethylene units: 62 wt %; propylene units: 38 wt % (taking the total of ethylene units and propylene units as 100 wt %); iodine value: 2.6; density (in a state of containing 40 parts by weight of oil to 100 parts by weight of the copolymer): 880 kg/m³; Mooney iscosity (ML₁₊₄(100° C.)) (in the said state): 76.

Ethylene-propylene-5-ethylidene-2-norbornene copolymer rubber formed in the second polymerization reactor:
Ethylene units: 62 wt %; propylene units: 38 wt % (taking the total of ethylene units and propylene units as 100 wt %); iodine value: 7.4; density (in a state of containing 40 parts by weight of oil to 100 parts by weight of the copolymer): 880 kg/m³; Mooney viscosity (ML₁₊₄(100° C.)) (in the said state): 76.

The weight ratio of the amount of the monomers reacted in the first polymerizaer to that in the second polymerization reactor was 2 to 1. The structure of the copolymer formed in the second polymerization reactor was determined by calculations from the structure of the copolymer mixture obtained at the outlet of the second polymerization reactor, the structure of the copolymer obtained at the outlet of the first polymerization reactor and the ratio of the amounts of the monomers reacted in the respective polymerization reactors.

### AB-3: Ethylene-propylene-5-ethylidene-2-norbornene Copolymer Rubber

The same procedure as used for AB-1 was conducted using two polymerization reactors connected in series to produce a mixture of ethylene-propylene-5-ethylidene-2-norbornene copolymer rubbers differing in structure.

Ethylene-propylene-5-ethylidene-2-norbornene copolymer rubber as a mixture:
Ethylene units: 63 wt %; propylene units: 37 wt % (taking the total of ethylene units and propylene units as 100 wt %); iodine value: 4.2; oil content: 40 parts by weight to 100 parts by weight of the ethylene-propylene-5-ethylidene-2-norbornene copolymer; density (in an oil-containing state): 880 kg/m³; Mooney viscosity (ML₁₊₄(100° C.)) (in an oil-containing state): 80.

Ethylene-propylene-5-ethylidene-2-norbornene copolymer rubber formed in the first polymerization reactor:
Ethylene units: 63 wt %; propylene units: 37 wt % (taking the total of ethylene units and propylene units as 100 wt %); iodine value: 4.9; density (in a state containing 40 parts by weight of oil to 100 parts by weight of the ethylene-propylene-5-ethylidene-2-norbornene copolymer): 880 kg/m³; Mooney viscosity (ML₁₊₄(100° C.)) (in the said state): 80.

Ethylene-propylene-5-ethylidene-2-norbornene copolymer rubber formed in the second polymerization reactor:
Ethylene units: 63 wt %; propylene units: 37 wt % (taking the total of ethylene units and propylene units as 100 wt %); iodine value: 2.7; density (in a state containing 40 parts by weight of oil to 100 parts by weight of the ethylene-propylene-5-ethylidene-2-orbornene copolymer): 880 kg/m³; Mooney viscosity (ML₁₊₄(100° C.)) (in the said state): 80.

The weight ratio of the amount of the monomers reacted in the first polymerizaer to that in the second polymerization reactor was 2 to 1. The structure of the copolymer formed in the second polymerization reactor was determined by calculations from the structure of the copolymer mixture obtained at the outlet of the second polymerization reactor, the structure of the copolymer obtained at the outlet of the first polymerization reactor and the ratio of the amounts of the monomers reacted in the respective polymerization reactors.

### AB-4: Ethylene-propylene-5-ethylidene-2-norbornene Copolymer Rubber

Ethylene units: 70 wt %; propylene units: 30 wt % (taking the total of ethylene units and propylene units as 100 wt %); iodine value: 7.5; oil content: 40 parts by weight to 100 parts by weight of the ethylene-propylene-5-ethylidene-2-norbornene copolymer; density (in an oil-containing state): 880 kg/m³; Mooney viscosity (ML₁₊₄(100° C.)) (in the said state): 78.

### AB-5: Ethylene-propylene-5-ethylidene-2-norbornene Copolymer Rubber

Ethylene units: 63 wt %; propylene units: 37 wt % (taking the total of ethylene units and propylene units as 100 wt %); iodine value: 3.6; oil content: 40 parts by weight to 100 parts by weight of the ethylene-propylene-5-ethylidene-2-norbornene copolymer; density (in an oil-containing state): 880 kg/m³; Mooney viscosity (ML₁₊₄(100° C.)) (in an oil-containing state): 75.

### (3) Homopolypropylene

C-1: Norbrene Z101A produced by Sumitomo Chemical Co. MFR: 25 g/10 min.

### Example 1

A1-1, B1-1 and C-1 of the blending ratios shown in Table 1 (taking the total of A1-1, B1-1 and C-1 as 100 parts by weight) plus 0.18 part by weight of trimethylolpropane trimethacrylate (crosslinking assistant) were melted and mixed by a Banbury mixer and then palletized. The pellets were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting A1-1+B1-1+C-1=100 parts by weight) was added and the mixture was subjected to a dynamic heat treatment to produce a thermoplastic elastomer composition. This composition was molded into a product and its properties were determined. Results are shown in Table 1.

### Example 2

A1-2, B1-2 and C-1 of the blending ratios shown in Table 1 (taking the total of A1-2, B1-2 and C-1 as 100 parts by weight) plus 0.18 part by weight of trimethylolpropane trimethacrylate (crosslinking assistant) were melted and mixed by a Banbury mixer and then palletized. The pellets were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting A1-2+B1-2+C-1=100 parts by weight) was added and the mixture was subjected to a dynamic heat treatment to produce a thermoplastic elastomer composition. This composition was molded into a product and its properties were determined. Results are shown in Table 1.

### Comparative Example 1

A1-3, B1-3 and C-1 of the blending ratios shown in Table 1 (taking the total of A1-3, B1-3 and C-1 as 100 parts by weight) plus 0.18 part by weight of trimethylolpropane trimethacrylate (corsslinking assistant) were melted and mixed by a Banbury mixer and then palletized. The pellets were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting A1-3+B1-3+C-1=100 parts by weight) was added and the mixture was subjected to a dynamic heat treatment to produce a thermoplastic elastomer composition. This composition was molded into a product and its properties were determined. Results are shown in Table 1.

TABLE 1

| | Ethylene | Iodine | | | Comparative |
|---|---|---|---|---|---|
| | content | value | Example 1 | Example 2 | Example 1 |
| A1-1 | 67 | 3.9 | 29 | | |
| A1-2 | 64 | 3.6 | | 29 | |
| A1-3 | 63 | 3.6 | | | 29 |
| B1-1 | 57 | 4.4 | 29 | | |
| B1-2 | 51 | 3.9 | | 29 | |
| B1-3 | 63 | 3.6 | | | 29 |
| C-1 | | | 42 | 42 | 42 |
| Flexural | | | 230 | 230 | 220 |
| modulus | | | | | |
| Izod impact | | | NB | NB | B |
| Spiral | | | 523 | 547 | 505 |
| MFR | | | 9 | 12 | 7 |

### Example 3

A2-1, B2-1 and C-1 of the blending ratios shown in Table 2 (taking the total of A2-1, B2-1 and C-1 as 100 parts by weight) plus 0.18 part by weight of trimethylolpropane trimethacrylate (corsslinking assistant) were melted and mixed by a Banbury mixer and then palletized. The pellets were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting A2-1+B2-1+C-1=100 parts by weight) was added and the mixture was subjected to a dynamic heat treatment to produce a thermoplastic elastomer composition. This composition was molded into a product and its properties were determined. Results are shown in Table 2.

### Example 4

A2-2, B2-2 and C-1 of the blending ratios shown in Table 2 (taking the total of A2-2, B2-2 and C-1 as 100 parts by weight) plus 0.18 part by weight of trimethylolpropane trimethacrylate (corsslinking assistant) were melted and mixed by a Banbury mixer and then palletized. The pellets were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (lettting A2-2+B2-2+C-1=100 parts by weight) was added and the mixture was subjected to a dynamic heat treatment to produce a thermoplastic elastomer composition. This composition was molded into a product and its properties were determined. Results are shown in Table 2.

### Comparative Example 2

A2-3, B2-3 and C-1 of the blending ratios shown in Table 2 (taking the total of A2-3, B2-3 and C-1 as 100 parts by weight) plus 0.18 part by weight of trimethylolpropane trimethacrylate (corsslinking assistant) were melted and mixed by a Banbury mixer and then palletized. The pellets were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting A2-3+B2-3+C-1=100 parts by weight) was added and the mixture was subjected to a dynamic heat treatment to produce a thermoplastic elastomer composition. This composition was molded into a product and its properties were determined. Results are shown in Table 2.

TABLE 2

| | Ethylene | Iodine | | | Comparative |
|---|---|---|---|---|---|
| | content | value | Example 3 | Example 4 | Example 2 |
| A2-1 | 62 | 7.4 | 29 | | |
| A2-2 | 63 | 4.9 | | 29 | |
| A2-3 | 63 | 3.6 | | | 29 |
| B2-1 | 62 | 2.6 | 29 | | |
| B2-2 | 63 | 2.7 | | 29 | |
| B2-3 | 63 | 3.6 | | | 29 |
| C-1 | | | 42 | 42 | 42 |
| Flexural | | | 220 | 230 | 220 |
| modulus | | | | | |
| Izod impact | | | NB | NB | B |
| Izod impact | | | 63 | 49 | 19 |
| strength | | | | | |
| Spiral | | | 510 | 509 | 505 |
| MFR | | | 6 | 6 | 7 |

### Example 5

AB-1 and C-1 of the blending ratios shown in Table 3 (taking the total of AB-1 and C-1 as 100 parts by weight) and 0.18 part by weight of trimethylolpropane trimethacrylate (corsslinking assistant) were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting AB-1+C-1=100 parts by weight) was added and the mixture was subjected to a dynamic heat treatment to produce a thermoplastic elastomer composition. This composition was molded into a product and its properties were determined. Results are shown in Table 3.

### Example 6

AB-2 and C-1 of the blending ratios shown in Table 3 (taking the total of AB-2 and C-1 as 100 parts by weight) and 0.18 part by weight of trimethylolpropane trimethacrylate (corsslinking assistant) were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting AB-2+C-1=100 parts by weight) was added and the mixture was subjected to a dynamic heat treatment to produce a thermoplastic elastomer composition. This composition was molded into a product and its properties were determined. Results are shown in Table 3.

### Example 7

AB-3 and C-1 of the blending ratios shown in Table 3 (taking the total of AB-3 and C-1 as 100 parts by weight) and 0.18 part by weight of trimethylolpropane trimethacrylate (corsslinking assistant) were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting AB-3+C-1=100 parts by weight) was added and the mixture was subjected to a dynamic heat treatment to produce a thermoplastic elastomer composition. This composition was molded into a product and its properties were determined. Results are shown in Table 3.

### Comparative Example 3

AB-4 and C-1 of the blending ratios shown in Table 3 (taking the total of AB-4 and C-1 as 100 parts by weight) and 0.18 part by weight of trimethylolpropane trimethacrylate (corsslinking assistant) were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting AB-4+C-1=100 parts by weight) was added and the mixture was subjected to a dynamic heat treatment to produce a thermoplastic elastomer composition. This composition was molded into a product and its properties were determined. Results are shown in Table 3.

### Comparative Example 4

AB-5 and C-1 of the blending ratios shown in Table 3 (taking the total of AB-5 and C-1 as 100 parts by weight) and 0.18 part by weight of trimethylolpropane trimethacrylate (corsslinking assistant) were supplied into a double-screw extruder, and from a half-way spot of the extruder, 2.2 parts by weight of 2,5-dimethyl-2,5-di(t-butylperoxy)hexene (crosslinking agent) diluted to 10% concentration with a paraffin oil (0.22 part by weight as crosslinking agent) (letting AB-5+C-1=100 parts by weight) was added and the mixture was subjected to a dynamic heat treatment to produce a thermoplastic elastomer composition. This composition was molded into a product and its properties were determined. Results are shown in Table 3.

TABLE 3

| | | Ethylene | Iodine | | | | Comparative | Comparative |
|---|---|---|---|---|---|---|---|---|
| | | content | value | Example 5 | Example 6 | Example 7 | Example 3 | Example 4 |
| AB-1 | A | 57 | 4.4 | 58 | | | | |
| | B | 67 | 3.9 | | | | | |
| AB-2 | A | 62 | 2.6 | | 58 | | | |
| | B | 62 | 7.4 | | | | | |
| AB-3 | A | 63 | 4.9 | | | 58 | | |
| | B | 63 | 2.7 | | | | | |
| AB-4 | | 70 | 7.5 | | | | 58 | |
| AB-5 | | 63 | 3.6 | | | | | 58 |
| C-1 | | | | 42 | 42 | 42 | 42 | 42 |
| Flexural | | | | 220 | 220 | 220 | 240 | 220 |
| modulus | | | | | | | | |
| Izod impact | | | | NB | NB | NB | B | B |
| Izod impact | | | | 55 | 72 | 83 | 6 | 33 |
| strength | | | | | | | | |
| MFR | | | | 9 | 5 | 7 | 24 | 6 |

1. A thermoplastic elastomer composition obtained by mixing, at least, 15 to 40% by weight of a component (A1), 15 to 40% by weight of a component (B1) and 20 to 70% by weight of a component (C) (taking the total of the components (A1), (B1) and (C) as 100% by weight), said components being as specified below:
(A1): an ethylene-α-olefin-non-conjugated diene copolymer rubber having a density of 850 to 900 kg/m³, a Mooney viscosity (ML₁₊₄(100° C.)) of 30 to 150, an iodine value of 0.1 to 40, and an ethylene unit content of 30 to 90% by weight;
(B1): an ethylene-α-olefin-non-conjugated diene copolymer rubber having a density of 850 to 900 kg/m³, a Mooney viscosity (ML₁₊₄(100° C.)) of 30 to 150, an iodine value of 0.1 to 40, and an ethylene unit content which is 0.50 to 0.95 time that of the component (A1);
(C): a polypropylene resin.

2. A thermoplastic elastomer composition obtained by mixing, at least, 15 to 40% by weight of a component (A2), 15 to 40% by weight of a component (B2) and 20 to 70% by weight of a component (C) (taking the total of the components (A2), (B2) and (C) as 100% by weight), said components being as specified below:
(A2): an ethylene-α-olefin-non-conjugated diene copolymer rubber having a density of 850 to 900 kg/m³, a Mooney viscosity (ML₁₊₄(100° C.)) of 30 to 150, an ethylene unit content of 30 to 90% by weight, and an iodine value of 0.1 to 40;
(B2): an ethylene-α-olefin-non-conjugated diene copolymer rubber having a density of 850 to 900 kg/m³, a Mooney viscosity (ML₁₊₄(100° C.)) of 30 to 150, an ethylene unit content of 30 to 90% by weight, and an iodine value which is 0.25 to 0.95 time that of the component (A2);
(C): a polypropylene resin.

3. A thermoplastic elastomer composition according to claim 1 wherein the ethylene-α-olefin-non-conjugated diene copolymer rubbers of the components (A1), (A2), (B1) and (B2) are an oil-extended ethylene-α-olefin-non-conjugated diene copolymer rubber having an ethylene unit content of 40 to 80% by weight, an iodine value of 1 to 30, and an oil extension rate of 20 to 120 phr.

4. A thermoplastic elastomer composition according to claim 1 obtained by subjecting the component materials to a dynamic heat treatment in the presence of a crosslinking agent.

5. A thermoplastic elastomer composition according to claim 4 wherein the dynamic heat treatment is carried out in the presence of an organic peroxide or in the presence of an organic peroxide and a crosslinking assistant.

6. An air bag cover obtained by molding a thermoplastic elastomer composition set forth in claim 1.

7. A method of producing a thermoplastic elastomer composition of claim 1, which comprises the steps of:
using two polymerization reactors connected in series or parallel to each other;
forming the component (A1) in one of said polymerization reactors while forming the component (B1) in the other polymerization reactor;
forming a mixed solution of the components (A1) and (B1) being mixed in a solvent; then
removing the solvent from said mixed solution to obtain a mixture of the components (A1) and (B1); and
compounding and kneading the component (C) in this mixture so that the content of the component (A1) will become 15 to 40% by weight, the content of the component (B1) 15 to 40% by weight and the content of the component (C) 20 to 70% by weight.

8. A method of producing a thermoplastic elastomer composition of claim 2, which comprises the steps of:
using two polymerization reactors connected in series or parallel to each other;
forming the component (A2) in one of said polymerization reactors while forming the component (B2) in the other polymerization reactor;
forming a mixed solution of the components (A2) and (B2) being mixed in a solvent; then
removing the solvent from said mixed solution to obtain a mixture of the components (A2) and (B2); and
compounding and kneading the component (C) in this mixture so that the content of the component (A2) will become 15 to 40% by weight, the content of the component (B2) 15 to 40% by weight and the content of the component (C) 20 to 70% by weight.
